(19) United States
(12) Patent Application Publication
(10) Pub. No.: US 2015/0050616 A1
(43) Pub. Date: Feb. 19, 2015

(54) Dental Safety Device

(71) Applicant: Mary Ellen Hoye, Homer Glen, IL (US)

(72) Inventor: Mary Ellen Hoye, Homer Glen, IL (US)

(21) Appl. No.: 13/965,318

(22) Filed: Aug. 13, 2013

(51) Int. Cl. A61C 5/14

(52) U.S. Cl. CPC A61C 5/14
USPC 433/136

(57) ABSTRACT

A dental safety device that prevents any loose object from entering a patient's throat during a dental procedure. A piece of gauze-like breathable fabric is either tied in the mouth or is equipped with side extensions attached to elastic loops or an elastic band. In use, the device is placed flat in the mouth behind the area where the dentist is working. The extensions exit the mouth on either side and wrap backward. The device is held in place by the elastic loops or elastic band, or tied directly to teeth. The nature of the fabric allows easy breathing, and the device is comfortable for the patient to wear. At the end of the procedure, the device is easily removed and discarded.

### BACKGROUND

1. Field of the Invention

The present invention relates to the field of dentistry and more particularly to dental safety device that prevents objects crowns, teeth, instruments, fillings and less bacteria from being swallowed or aspirated (bacteria from entering the body) during dental procedures.

2. Description of the Problem

Typically dentists perform procedures on patients with the patient seated in a reclining chair with the chair reclined backward at a steep angle or with the patient totally prone. During the procedure, the patient's mouth is open while the dentists inserts instruments, drills, crowns, filling material, gauze and numerous other items into the patient's mouth necessary to perform the procedure. Given the position of the patient, there is a constant danger that some item such as a crown will be dropped or otherwise become loose in the mouth and enter the throat area either causing the patient to swallow it, or worse yet, entering the lungs, larynx.

It would be advantageous to have a dental safety device that can prevent a loose object from entering the throat, lungs and body in prevention of gagging, swallowing or aspiration—without hampering breathing, causing gagging or in any way interfering with the dentist or causing discomfort to the patient.

### SUMMARY OF THE INVENTION

The present invention relates to a dental safety device that prevents any loose object from entering a patient's throat during a dental procedure. The present invention includes an approximately oval (any shape may be used that covers the throat and allows for extension and patient comfort) piece of gauze-like breathable fabric that is equipped with side extensions attached to elastic loops or an elastic band. In use, the device is placed flat in the mouth behind the area where the dentist is working. The extensions exit the mouth on either side and wrap backward. The device is held in place by the elastic loops or elastic band. The nature of the fabric allows easy breathing, and the device is comfortable for the patient to wear. At the end of the procedure, the device is easily removed and discarded. A second embodiment is a substantially rectangular piece of gauze-like material that is tied to the teeth. This embodiment can be used to partially or totally cover an area of the mouth or throat.

### DESCRIPTION OF THE FIGURES

Several drawings and illustrations are now presented to illustrate features of the present invention:

FIG. 1 shows a first embodiment of the present invention.

FIG. 2 shows the embodiment of FIG. 1 in use during a dental procedure.

FIG. 3 shows a diagram of the first embodiment.

FIG. 4 shows a second embodiment of the present invention.

FIG. 5 shows how the embodiment of FIG. 4 is used in a dental procedure.

Illustrations have been presented to aid in understanding the present invention. The scope of the present invention is not limited to what is shown in the figures.

### DESCRIPTION OF THE PREFERRED EMBODIMENT

As previously stated, a first embodiment of the present invention includes an approximately oval piece of gauze-like breathable fabric that is equipped with side extensions attached to elastic loops or an elastic band. While oval is the preferred shape, any other convenient shape may be used. In use, the device is placed flat in the mouth behind the area where the dentist is working. The extensions exit the mouth on either side and wrap backward. The device is held in place by the elastic loops or elastic band either around the ears or around the head.

Any breathable fabric may be used for to construct the device, and breathable fabric may be combined with non-breathable parts in regions of the device where breathing is not important. Since it will become somewhat moist during use, the fabric should not be adversely affected by moisture. The preferred fabric is the gauze-like material used to make surgical masks; however, any similar material may be used It is important that the device does not cause difficulty in breathing and not cause the patient to gag.

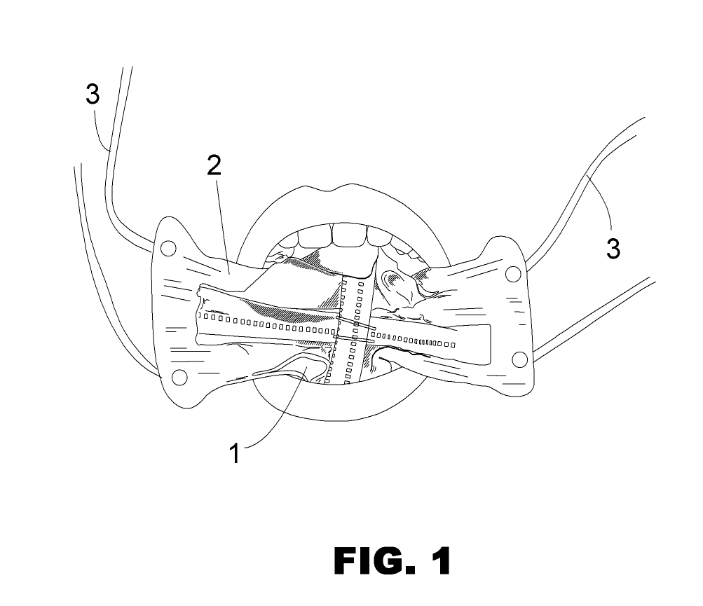

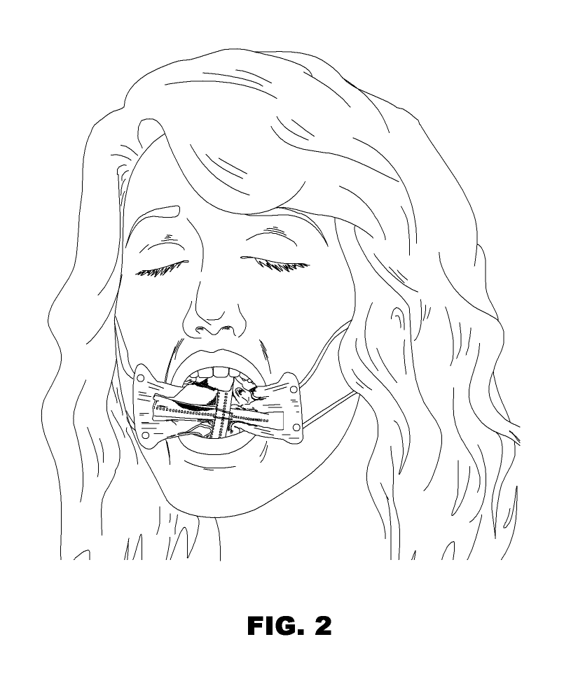

Turning to FIGS. 1-2, an embodiment of the present invention can be seen in use in a patient's mouth. The central portion 1 is approximately oval and protects the throat. While oval has been shown, any shape is within the scope of the present invention. Extensions 2 leave the oval 1 on each side. An optional wider section connects to loops 3 or a band at the outer ends.

This configuration causes the entire throat area to be protected. Optional seams may be used to hold the parts together. The parts may be sewed, wired, tied, connected by adhesive or kept together by any other means. Alternative embodiments may be made as a single complete piece.

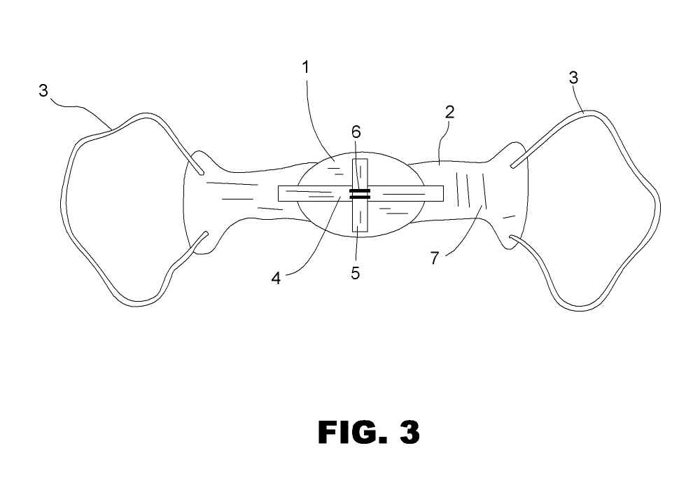

FIG. 3 shows a diagram of an embodiment of the invention. Extensions 2 leave the oval 1 on each side. An optional wider section connects to loops 3 or a band at the outer ends. The wider sections are optional and for ease of attachment and may be omitted in some embodiments. Strips of supporting material 4, 5 may be used to stiffen the oval 1 and hold it in place. An optional wire 6 may be used near the center of the oval 1 or supporting strips 4, 5 for retention and/or shaping the device.

An ultra thin wire similar to ribbon wire can surrounded by a cotton fabric to shape the fabric. During the procedure the patient may close the mouth, and the fabric will moisten; the wire helps it retain it's shape and be reshaped without causing discomfort to the patient. The device may be made totally of breathable material, or a combination of breathable and non-breathable materials; it may be cotton, or a blend of cotton and other fabrics, especially synthetic fabrics known in the art. Synthetic fabrics include numerous polymer substances such as polyesters and others known in the art.

The device can be manufactured in larger or smaller sizes so as to fit different individuals and children as well as adults.

An alternate embodiment of the device may contain pleats 7 that allow extending the device to fit a particular patient's mouth. In this way, the device can be used with many different patients. It can also be made in different sizes, for example, smaller sizes for children.

Other shapes besides elliptical may be used such as an octagon or half moon, round or even rectangle could achieve the same or similar effect. Any shape of any material breathable or non (nitrile) (may be all one fabric or a combination of many) that can be extended across the back or the mouth, anterior to the throat and attached to the patient with either smaller floss like loops around certain teeth of elastic larger loops to extend around the patients ears or with a head band is within the scope of the present invention.

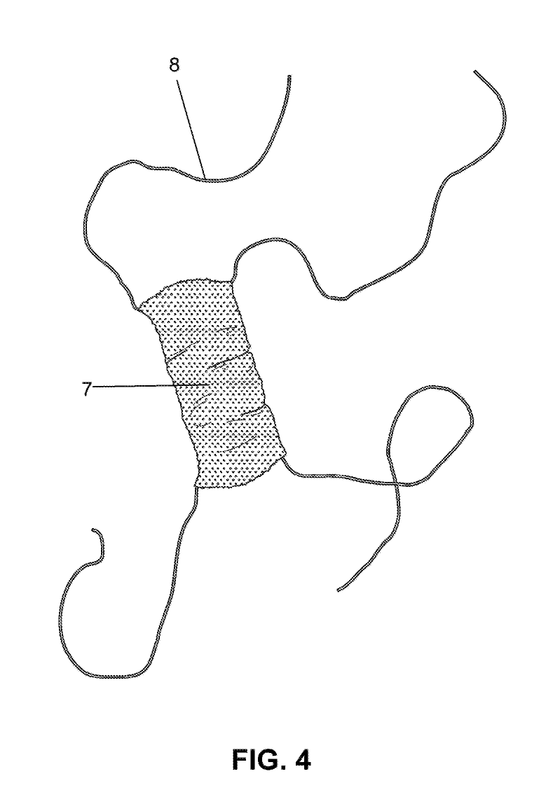

FIG. 4 shows a second embodiment of the present invention. This is a substantially rectangular piece of gauze-like material 7 (or any other shape). It has around tie strings 8 for tying the invention to various teeth. The device can be positioned to partially or totally cover the throat area and can be adjusted by the dentist during use.

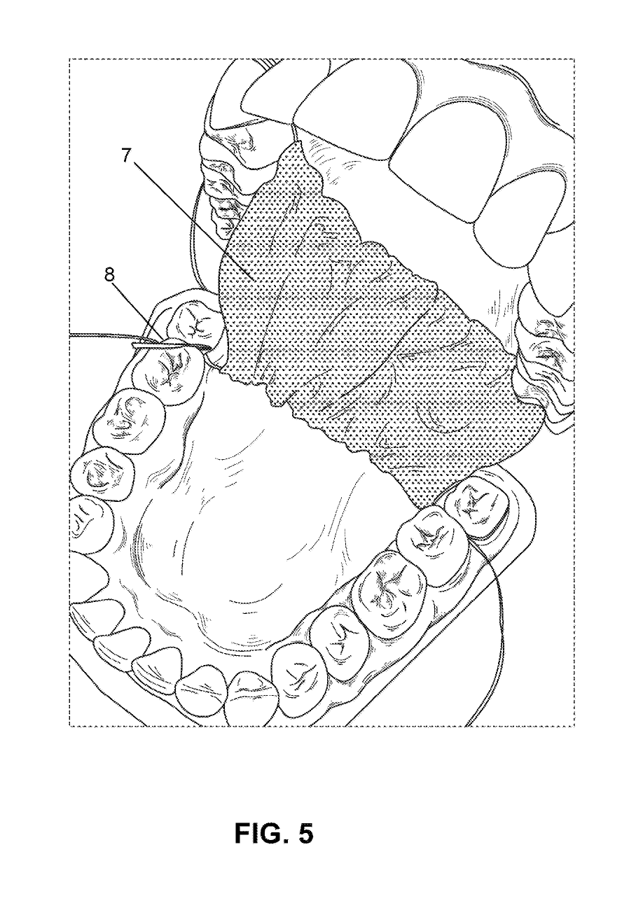

FIG. 5 shows the embodiment of FIG. 4 as it could be used in a dental procedure. As stated, the device 7 can be tied to any teeth to position it as desired. The device can have any number of tie strings. Any method that holds any of the devices of the present invention in a patient's mouth is within the scope of the present invention.

The devices of the present invention can be discarded after use.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A dental safety device that prevents objects from entering a patient's throat comprising:
an elongated flexible strip containing breathable material adapted to be placed in a patient's mouth during a dental procedure,
an elastic loop, band or a set of tie strings attached to a distal end of said flexible strip adapted to either loop around said patient's ears, loop around said patient's head or tie to adjacent teeth.

2. The dental safety device of claim 1 further comprising said flexible strip having extensions left and right adapted to exit from the mouth left and right, wherein an elastic loop is attached to the distal end of each of the extensions, the elastic loop adapted to fit around a patient's ears.

3. The dental safety device of claim 1 further comprising at least one stiffening member attached to said flexible strip adapted to hold the shape of said flexible strip in use.

4. The dental safety device of claim 3 further comprising two stiffening members at substantially right angles.

5. The dental safety device of claim 1 further comprising said flexible strip having extensions left and right adapted to exit from the mouth left and right, wherein an elastic band is attached to the distal end of each of the extensions, the elastic band adapted to loop around said patient's head.

6. The dental safety device of claim 2 further comprising pleats on each of said extensions, said pleats adapted to allow extending the extensions for fitting different patients.

7. The dental safety device of claim 5 further comprising pleats on each of said extensions, said pleats adapted to allow extending the extensions for fitting different patients.

8. The dental safety device of claim 1 wherein the breathable material is cotton gauze or blend of cotton and synthetic fabrics.

9. A dental safety device used for in-mouth dental procedures to keep debris and foreign objects from entering a patient's throat comprising a fabric mouth insert made totally from breathable or gauze-like material or a combination of breathable and non-breathable materials, the fabric mouth insert adapted to partially or totally cover the patient's throat, the fabric mouth insert having extensions exiting the mouth left and right, said extensions having either a pair of ear loops left and right or a head band, the fabric mouth insert having at least one stiffening member.

10. The dental safety device of claim 9 further comprising pleats on each of the extensions, the pleats adapted to allow extending the extensions for fitting different patients.

11. The dental safety device of claim 9 wherein the breathable material is cotton gauze or blend of cotton and synthetic fabrics.

12. A dental safety device used for in-mouth dental procedures to keep debris and foreign objects from entering a patient's throat comprising a fabric mouth insert made from breathable gauze-like material, the fabric mouth insert adapted to partially or totally cover the patient's throat, the fabric mouth insert having a plurality of tie strings adapted to secure the mouth insert to adjacent teeth.

13. The dental safety device of claim 12 wherein said device has four tie stings.

14. The dental safety device of claim 12 wherein said fabric mouth insert is substantially rectangular.

15. The dental safety device of claim 12 wherein the breathable material is cotton gauze or blend of cotton and synthetic fabrics.

16. The dental safety device of claim 13 wherein said fabric mouth insert is substantially rectangular.

17. The dental safety device of claim 16 wherein the breathable material is cotton gauze or blend of cotton and synthetic fabrics.

18. The dental safety device of claim 12 wherein said fabric mouth insert is substantially rectangular.

19. The dental safety device of claim 18 wherein the breathable material is cotton gauze or blend of cotton and synthetic fabrics.
